(19) United States
(12) Patent Application Publication
(10) Pub. No.: US 2007/0067918 A1
(43) Pub. Date: Mar. 29, 2007

(54) Method and apparatus for dyeing fibers

(75) Inventor: Kishor Gajanan Agnihotri, GUJARAT (IN)

Correspondence Address: NATH & ASSOCIATES, 112 South West Street, Alexandria, VA, 22314, US

(73) Assignee: ARVIND MILLS LTD., GUJARAT (IN)

(21) Appl. No.: 10/576,490

(22) PCT Filed: Oct. 12, 2004
(86) PCT No.: PCT/IN04/00318

§ 371 Date: Apr. 20, 2006

(30) Foreign Application Priority Data
Oct. 21, 2003 (IN) 1117/MUM/2003

(51) Int. Cl. C11D 3/00

(52) U.S. Cl. 8/115.51

(57) ABSTRACT

The present invention relates to a method and an apparatus for dyeing cotton at fiber stage and a method for preparing yarn. The present invention provides an apparatus (100) for dyeing fibers and filaments comprising plurality of pre-wetting troughs (18), plurality of dye baths (20), and a drying arrangement (22) characterized in having a supporting system (14) for carrying and dyeing the fiber (12) continuously and homogeneously. The fibers or filamnents for dyeing includes cotton and other natural fibers, man made and synthetic fibers as well as filamnents and a combination thereof. The fiber for dyeing according to the present invention is cotton fiber. A method for dyeing according to the present invention comprising the steps of carrying the cotton fiber (12) along with supporting system (14); prewetting the cotton fiber (12) along with supporting system (14); dyeing of cotton fiber (12) along with the supporting system (14); and drying of the cotton fiber (12) wherein the cotton fiber (12) is dyed continuously and homogeneously. The dye used for dyeing is the indigo dye.

### FIELD OF INVENTION

The present invention relates to the field of dyeing fibers, particularly, the present invention relates to a method and apparatus for dyeing fibers, particularly, raw cotton fiber using various dyes, especially, Indigo dye.

### BACKGROUND OF THE INVENTION:

Conventionally, indigo dyeing is carried out at yarn stage either by slasher, rope or hank processing method. Such method of dyeing yarn especially using indigo dye has certain inherent limitations as described herein:

Generally, due to low absorbing capacity of yarn, dyeing at yarn stage results in dyeing of the yarn only at the surface, without sufficient or adequate penetration of the dye into core of the yarn. Further, yarn has to be dyed multiple times for obtaining a particular dark color. Another limitation of such method is its inability to dye relatively finer counts. Furthermore, the above method does not permit dyeing of lesser number of yarn threads/ropes due to reasons such as configuration and suitability of the dyeing machine.

In an attempt to overcome the drawbacks of dyeing at yarn stage, methods have been developed to replace conventional dyeing after spinning into dyeing before spinning.

One such method of dyeing before spinning is disclosed in U.S. Pat. No. 3,660,014 by Kabushiki Kaisha Yamadakuma Senkojo, Japan. The U.S. Pat. No. 3,660,014 discloses a method of continuously treating or dyeing cotton and other fibres and apparatus therefor, comprising a mechanism whereby cotton and other fibre are saturated uniformly with dye liquor or treating liquor and are fed to a fibre receiving pipe having a steeply sloped inner surface. A pressing mechanism presses cotton and other fibre into the cotton-receiving pipe intermittently in the state of layers. A cylindrical steam heater is provided below the fiber-receiving pipe. A mechanism imparts a sealing force to the lower end of said steam heater and a horizontal steam heater for secondary steam heating.

However, the method of dyeing cotton at fiber stage as disclosed in U.S. Pat. No. 3,660,014 is particularly suitable for batch production and the above process is not readily suitable for indigo dyeing.

Due to growing demand particularly for indigo dyed textile fabric, continuous dyeing has always been favoured by the industry, and is also commercially feasible.

Even though continuous dyeing methods are available for indigo dyeing at yarn stage, the existing methods are not readily suitable for dyeing fibers, particularly, cotton at fiber stage as the cotton fibers do not withstand the tension during dyeing in continuous manner as dyeing yarns. Further, the fibers, particularly, cotton fibers when passed through the dyeing machine suitable for yarns, fiber slippage occurs resulting in opening out of the fibers in the dyeing machine. Due to the drawbacks associated with such method as described in above, there exists a need to develop methods for continuous dyeing of fibers, particularly, cotton at fiber stage.

Our inventors have proposed a method and apparatus for dyeing cotton continuously at fiber stage particularly using indigo dye, which would overcome the drawbacks and find a solution to the problems associated with the prior art dyeing methods and apparatuses especially for indigo dyeing.

### OBJECTS OF THE INVENTION:

An object of the present invention is to provide a method and apparatus for dyeing cotton at fiber stage wherein dyeing is done continuously to suit mass production.

An object of the present invention is to provide a method and apparatus for dyeing cotton at fiber stage wherein dyeing enables obtaining uniform combination of a plurality of colors in the fabric.

Another object of the present invention is to provide a method and apparatus for dyeing cotton at fiber stage wherein dyeing enables obtaining different colors on either side of the fabric by using different colors for warp and weft yarns.

Another object of the present invention is to provide a method and apparatus for dyeing cotton at fiber stage for developing indigo dyed melange yarns for several end purposes.

Yet another object of the present invention is to provide a method and apparatus for dyeing cotton at fiber stage wherein dyeing enables blending of synthetic fibers such as polyester fibers imparted with anti bacterial and fluorescent properties with cotton fibers thereby resulting in imparting special properties to the fabric.

### SUMMARY OF INVENTION

The present invention provides an apparatus for dyeing fibers and filaments comprising plurality of pre-wetting troughs, plurality of dye baths, and a drying arrangement characterized in having a supporting system for carrying and dyeing the fiber continuously and homogeneously. The fibers or filaments for dyeing includes cotton and other natural fibers, man made and synthetic fibers as well as filaments and a combination thereof. The fiber for dyeing according to the present invention is cotton fiber. The supporting system according to the present invention comprises a belt for carrying and dyeing fiber. The belt is usually a porous belt that is inert for dyeing. The belt is made from a synthetic or a natural fabric. The supporting system according to the present invention considerably reduces the fibers from being broken or perfused during the dying process.

Another embodiment of the present invention provides a method for dyeing fiber comprising carrying fibers using a supporting system; pre-wetting the fibers along with the supporting system; dyeing fibers with the supporting system; and drying the fibers whereby reducing fiber perfusion and continuously and homogeneously dyeing the fiber. The fibers or filaments for dyeing includes cotton and other natural fibers, man made and synthetic fibers as well as filaments and a combination thereof. The cotton fiber is prepared into a rope and carried between the supporting systems during dyeing process. The cotton fibers are dyed using Indigo dye.

Another embodiment of the present invention provides a method of dyeing fibers, particularly, cotton fibers without using a support system wherein prewetting the fibers in roving form, dyeing fibers in roving form, and drying the fibers in roving form wherein fibers are dyed continuously and homogeneously. Further, the dyed roving is directly or indirectly spun into yarn.

Another embodiment of the present invention provides a method of dyeing fibers without using a support system comprising the steps of forming a tow form of filaments; prewefting the filaments in tow form; dyeing the filaments in tow form; drying the filaments in tow form; wherein the filaments are dyed continuously and homogenously.

Another embodiment of the present invention is a method for preparing indigo dyed melange yarn comprising the steps of blending indigo dyed cotton fibers prepared according to one of the methods as described above with undyed/dyed fibers and spinning the fibers to produce indigo dyed melange yarns. The fibers or filaments for dyeing includes cotton and other natural fibers, man made and synthetic fibers as well as filaments and a combination thereof.

The present invention provides a system and method for dyeing fibers, particularly, cotton fibers continuously and homogenously. The method according to the present invention enables the fibers to be dyed separately and/or in combination thereof.

### BRIEF DESCRIPTION OF DRAWINGS

FIG. 1 shows side view of apparatus with support system for dyeing fibers.

FIG. 2 shows side view of apparatus arrangement for dyeing fibers without support system.

### DESCRIPTION OF INVENTION

The present invention discloses a method and an apparatus for dyeing cotton at fiber stage and a method for preparing yarn.

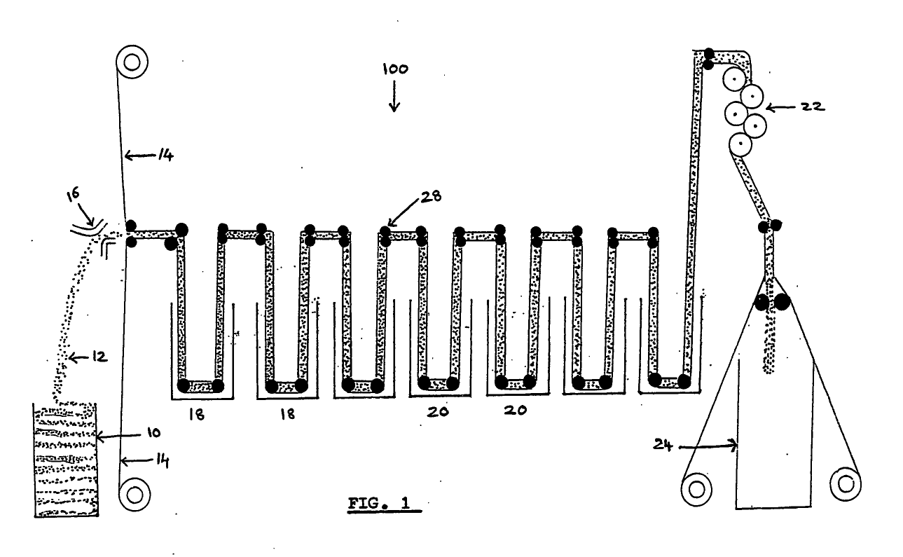

An apparatus (100) according to present invention as shown in FIG. 1 comprises a fiber rope can (10) for holding fiber rope (12). The fiber rope (12) is carried by supporting system (14) through a guide plate (16). The supporting system (14) is arranged in such a manner that the fiber rope is passed in between the supporting system (14). The supporting system (14) is arranged in pair according to the present invention. Preferably the supporting system is arranged in rolls to carry the fiber rope. The supporting system (14) may preferably be porous so that the dye passes through the supporting system and the fiber is dyed uniformly. According to the present invention, preferably, the supporting system is inert to dyeing so less dye is consumed by the supporting system. The supporting system (14) according to the present invention is a fabric roll which is inert to dyeing. The supporting system (14) is made from a natural fabric or a synthetic or a mixed fabric that is formed into a roll. The support system according to the present invention considerably reduces the cotton fibers being broken and perfused during the continuous process of dyeing. The support system according to the present invention also eliminates the fiber slippage which generally occurs when fibers are passed directly through the yarn dyeing machine.

Further, the supporting fabric used in this process is to support the slivers to take up the tension between the guide rollers during the process thereby allowing the fiber ropes to flow freely into the dyeing machine without getting disturbed due to tension during the process. A creeling arrangement (not shown in figure) for feeding of supporting fabric is done separately and is guided manually to feed to the guide rollers without any crease at the edges. The creeling arrangement may optionally be operated automatically to ease the operation.

The fiber ropes (12) are guided into the plurality of pre-wetting troughs (18) along with the supporting system (14) to pre-treat the fiber for better dyeability during dyeing operation. The fiber ropes (12) are then taken through a sequence of dyeing baths (20) with specific concentration of dye for example indigo to dye the fibers to the required colour depth. The number of dyeing baths shall vary from 3 to 8 depending upon the final shade requirement. The dye concentration would vary as per the required depth of colour in the fiber. Nip rollers (28) are used to guide the fiber ropes (12) along with supporting system (14) to pass from one trough or bath or can to the other. The dyed fiber ropes (12) are then passed through drying cylinders (22) located at the delivery end of rope dyeing machine. The drying cylinders (22) are maintained at a temperature of about 90 to 95 degree Celsius. The dried fiber ropes are collected in collection cans (24) and the supporting system (14) are collected separately without affecting the collection of ropes in cans.

Alternatively, the support mechanism may comprise a bucket conveyor wherein the buckets have pores for allowing entry of dye into the bucket and are adapted to carry a predetermined volume of cotton fiber for dyeing.

A method for dyeing according to the present invention comprising the steps of carrying the cotton fiber along with supporting system; prewetting the cotton fiber along with supporting system; dyeing of cotton fiber along with the supporting system; and drying of the cotton fiber wherein the cotton fiber is dyed continuously and homogeneously. The dye used for dyeing is the indigo dye and/or shall be selected from the group comprising vat dye, sulfur dye, reactive dye, direct dye or any other dye suitable for use with cotton and/or cellulosic. Particularly, this method is suitable for use with indigo dye.

The cotton fiber is carried in either a loose form, sliver form, or an intermediate form using the support system (14) for immersion into the dye baths of a conventional rope/slasher dyeing machine. The raw material used in cotton sliver is prepared from cotton mix. The selection of cotton was done so as to prepare coarse to finer counts with more fanciness. The cotton type selected includes with fiber length of about 25 to 33 mm; 24 to 37 g/tex fiber strength, 85% uniformity ratio; 3.0 to 5.0 micronaire 3.3 short fiber percentage to obtain a substantially good yarn count.

The cotton slivers from the finisher draw frame are preferably combined to prepare a fiber rope. The fiber ropes are then fed to the rope-dyeing machine through appropriate guide plates for dyeing purpose.

The fiber ropes prepared are further doubled together during creeling to increase the size of rope and thus the fiber volume. Generally, around 8 fiber ropes are combined together to pass through a rope guide. Around 5 such combined ropes are passed through guide rollers to support the slivers during dyeing process.

The fibers along with the supporting system (14) are subjected to multiple dipping in dye baths preferably indigo dye baths. Subsequent to dyeing, the fiber ropes are passed through cold and hot water troughs to wash away the dye particles, which are not fixed to the fiber structure.

The dyed fibers are subjected to primary drying at 90 to 95 degree Celsius. The dried ropes may have some residual moisture in fiber, which needs to be further dried to make it suitable for spinning processes. The dyed fibers are collected separately and the supporting fabric is collected separately. The final drying operation is done by using conventional drying methods such as in drying chambers or in open atmosphere to the desired level before subjecting the ropes for opening.

The ropes are then opened thoroughly before taking the fiber for spinning operation. The ropes are broken into bigger tufts manually or mechanically and then bigger tufts are opened into smaller tufts before feeding into the spinning line. The tuft sizes are made into very small size by thorough opening. Fiber opening apparatus may also be used to open the fiber.

The opened dyed fibers are then packed in the required form to spin into yarns.

The dyed fibers are then spun separately up to combing stage according to standard spinning process. The combed slivers made from dyed fibers are used to prepare different melange yarns with different proportion of dyed fibers.

Fibers other than cotton fibers can also be dyed using this apparatus and method as described above. The fibers or filaments for dyeing includes cotton and other natural fibers, man made and synthetic fibers as well as filaments and a combination thereof. A person skilled in the art may arrive at dyeing of various other fibers having similar properties as described herein the specification using the method and apparatus of the present invention.

In this application, the scope of the term “support system” is not only limited to the embodiments referred to therein the description but also includes various means and forms of carrier devices that may be provided for carrying fibre in the form of sliver, loose or intermediate forms for dyeing by dipping into the dye baths in a continuous fashion.

Such method of carrying fiber using a support system enables continuous dyeing and hence mass production.

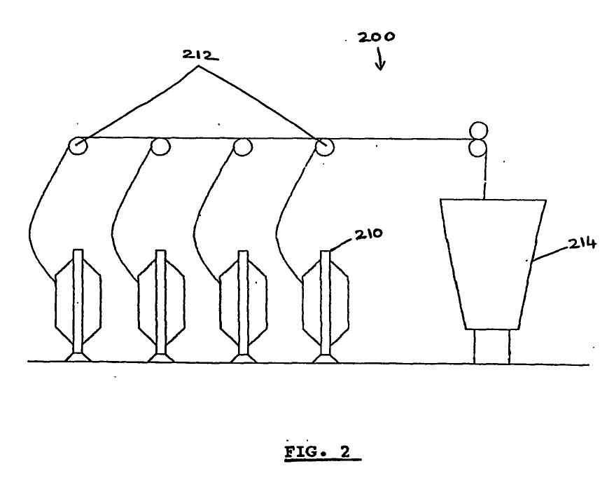

According to another embodiment of the present invention, the cotton fibers are dyed without using support system. The cotton fibers in the roving stage are passed on to the conventional yarn dyeing machine and dyed in similar manner as that of the yarn. FIG. 2 shows a side view of the dyeing apparatus arrangement (200) having a roving bobbin (210) and series of guide member (212) guiding the roving into the dyeing machine (214). The dyeing apparatus (214) used for dyeing the roving fibers are conventional indigo yarn dyeing machine. Using the conventional yarn dyeing apparatus, the synthetic fibers as well as man made fibers in roving form is dyed separately or along with cotton fibers continuously and homogenously. The dyed fibers obtained from this process may directly be spun into yarns. A method for dyeing fiber comprising the steps of forming a roving form of fiber; prewefting the roving form; dyeing the roving form; drying the roving form wherein the fibers are dyed continuously and homogenously. According to another embodiment of the present invention, the fibers in the tow form is dyed using the above process and a similar arrangement without using a support system.

According to another embodiment of the present invention, a method of preparing indigo dyed melange yarn comprising the steps of blending indigo dyed fibers with un-dyed or other coloured dyed fibers and spinning the indigo melange yarns; spinning yarn directly from dyed fibers. The undyed cotton slivers prepared through standard spinning techniques are utilized for this purpose. The dyed and undyed slivers are blended in different ratio to produce different fancy effects in the yarns. The major blends include 80/20; 67/33; 50/50 with undyed and dyed combination gave good results. The blended slivers were taken through both open end spinning and ring spinning for preparing yarns of different counts of melange yarns. Core spun melange yarns are also made by using lycra in the core through core spinning technology.

The other advantages of the invention are apparent form the description.

1. An apparatus for dyeing fiber or filament comprising:
a plurality of prewetting troughs;
a plurality of dye baths; and
a drying arrangement;
characterized in having a supporting system for carrying and dyeing the fiber continuously and homogenously.

2. An apparatus for dyeing fiber or filament as claimed in claim 1, wherein the supporting system comprises a belt for carrying and dyeing fiber.

3. An apparatus for dyeing fiber or filament of claim 2, wherein the belt is a porous belt.

4. An apparatus for dyeing fiber or filament of claim 1, wherein the supporting system comprises at least two belts to carry and dye the fiber.

5. An apparatus for dyeing fiber or filament of claim 1, wherein cotton fiber is carried between the porous belts.

6. An apparatus for dyeing fiber or filament of claim 1, wherein the belt is a synthetic or natural fabric.

7. An apparatus as claimed in claim 2, wherein the belt is a blended fabric.

8. An apparatus as claimed in claim 1, wherein the supporting system is inert to dyeing.

9. An apparatus for dyeing cotton fiber of claim 5, wherein the supporting system is a porous tubular network.

10. A method for dyeing fibers comprising:
carrying the fibers using a supporting system;
pre-wetting the fibers along with the supporting system;
dyeing the fibers along with the supporting system with a dye; and
drying the fibers,
wherein the dyeing of fibers is continuous and homogeneous.

11. A method for dyeing fibers as claimed in claim 10, wherein the fiber is carried between the supporting systems.

12. A method for dyeing fibers as claimed in claim 10, wherein the fibers for dyeing includes fibers selected from the group consisting of cotton, other natural fibers, man made fibers, synthetic fibers, filaments and combinations thereof.

13. A method for dyeing fibers as claimed in claim 10, wherein the fiber is cotton fiber.

14. A method for dyeing fiber as claimed in claim 13, further comprising the step of preparing a fiber rope for carrying cotton fibers.

15. A method for dyeing fiber as claimed in claim 10, wherein the dye is selected from the group consisting of indigo, vat dye, sulfur dye, reactive dye, and combinations thereof.

16. A method for dyeing fiber as claimed in claim 10, wherein the fibers are indigo dyed.

17. A method for dyeing fiber comprising the steps of:
forming a roving form of fiber;
prewetting the fiber in the roving form;
dyeing the fiber in the roving form; and
drying the fiber in the roving form;
wherein the fiber is dyed continuously and homogenously.

18. A method for dyeing fiber as claimed in claim 17, wherein the roving form of fiber for dyeing is selected from the group consisting of cotton, other natural fibers, man made fibers, synthetic fibers, filaments and a combination thereof.

19. A method for dyeing fiber as claimed in claim 17, wherein the fiber for dyeing is cotton fiber.

20. A method for dyeing fiber comprising the steps of:
forming a tow form of filaments;
prewetting the tow form of filaments;
dyeing the tow form of filaments; and
drying the tow form of filaments;
wherein the tow form of filaments are dyed continuously and homogenously.

21. A method for preparing yarn comprising the steps of:
blending dyed fibers with un-dyed or other dyed fibers and spinning indgo melange yarns; and
spinning yarn directly from dyed fibers.
